(19) United States
(12) Patent Application Publication
(10) Pub. No.: US 2010/0295319 A1
(43) Pub. Date: Nov. 25, 2010

(54) WIND TURBINE

(75) Inventor: James W. Britnell, Ontario (CA)

Correspondence Address: HARNESS, DICKEY & PIERCE, P.L.C., P.O. BOX 828, BLOOMFIELD HILLS, MI, 48303, US

(73) Assignee: ENGAUGE CONTROLS INC., Lakeshore (CA)

(21) Appl. No.: 12/783,774

(22) Filed: May 20, 2010

Related U.S. Application Data
(60) Provisional application No. 61/180,157, filed on May 21, 2009.

(51) Int. Cl. F03D 9/00

(52) U.S. Cl. 290/55

(57) ABSTRACT

A wind turbine is provided. In another aspect, a hubless or hollow wind turbine includes a hubless and/or hollow alternator or generator. A further aspect employs a hubless and/or hollow wind turbine surrounding an elongated member such as a pre-existing structure. In yet another aspect, a hubless and/or hollow wind turbine employs a directly driven alternator or generator.

This application claims the benefit of U.S. Provisional Application No. 61/180,157, filed on May 21, 2009, which is incorporated by reference herein.

### BACKGROUND AND SUMMARY

The disclosure relates generally to wind turbines and more particularly to a wind turbine mounted and rotating around an elongated structure.

Many varieties of wind turbines are known. For example, it is common to employ a vertical mast with a horizontally extending axial hub around which rotates three elongated blades. These devices, however, are unsightly, noisy, require unique and dedicated mast structures, and need a large rotational clearance area for the blades.

A hubless wind turbine is disclosed in International PCT Patent Publication No. WO 2008/109784 entitled “Hubless Windmill” published to Condoor et al. on Sep. 12, 2008, which is incorporated by reference herein. This wind turbine, however, employs a complicated ring gear and indirectly driven generator configuration which are disadvantageously positioned to obstruct central mounting of the windmill. They also obstruct use of blades that are axially elongated but have radial depth. Furthermore, the practical mounting of this device is not disclosed despite the importance of such for real-world application.

Other vertical axis wind turbines and horizontal axis wind turbines have been experimentally attempted. Such devices typically employ a central hub as the rotational axis. One such example is disclosed in U.S. Pat. No. 6,309,172 entitled “Wind Turbine with Low Vertical Axis” which issued to Gual on Oct. 30, 2001, and is incorporated by reference herein. Nevertheless, it “is difficult to mount vertical-axis turbines on towers, meaning they are often installed nearer to the base on which they rest, such as the ground or a building rooftop. The wind speed is slower at a lower altitude, so less wind energy is available for a given size turbine. Air flow near the ground and other objects can create turbulent flow, which can introduce issues of vibration, including noise and bearing wear which may increase the maintenance or shorten the service life.” Wind Turbine, Wikipedia, (Apr. 30, 2009).

In accordance with the present invention, a wind turbine is provided. In another aspect, a hubless and/or hollow wind turbine includes a hubless or hollow alternator or generator. A further aspect employs a hubless and/or hollow wind turbine surrounding an elongated member such as a pre-existing structure. In yet another aspect, a hubless and/or hollow wind turbine employs a directly driven alternator or generator. Moreover, another aspect provides a vertical axis wind turbine including modularly stacked rotatable sections capable of rotating at different speeds. An additional aspect provides a hubless and/or hollow wind turbine mounted to a multi-functional, elongated structure which also supports a water tower reservoir, a power transformer or an overhead wire connected to a generator of the wind turbine. A method of assembling a wind turbine to an elongated structure is also provided. Furthermore, a method of operating a hubless and/or hollow wind turbine is disclosed.

The wind turbine of the present application is advantageous over conventional devices such that the present wind turbine is considerably more aesthetically pleasing, more compact in packaging size, integrated onto pre-existing structures and has reduced operating noise. The present wind turbine also advantageously has a less complex and direct drive transmission and/or allows for differing speeds between adjacent modularized units. Furthermore, there are cost and space utilization advantages of mounting the present wind turbine around an existing pole, tower or the like. Additional advantages and features of the present invention will become apparent from the following description and appended claims, taken in conjunction with the accompanying drawings.

### BRIEF DESCRIPTION OF THE DRAWINGS

FIG. 1 is a side elevational view showing the present wind turbine mounted to a water tower;

FIG. 2 is a side elevational view showing the wind turbine mounted to a portion of a pole;

FIG. 3 is a perspective view showing the wind turbine mounted to the pole;

FIG. 4 is a perspective view showing the wind turbine, with outer covers removed, mounted to the pole;

FIG. 5 is a diagrammatic bottom view showing the inner blades and outer wind diverters of the wind turbine;

FIG. 6 is a partially cross sectional view, taken along line 6-6 of FIG. 5, mounted to the pole;

FIG. 7 is a perspective view showing the inner blades and a generator of the wind turbine;

FIG. 8 is a side elevational view showing the inner blades and generator of the wind turbine;

FIG. 9 is a top diagrammatic view showing the inner blades of the wind turbine;

FIG. 10 is a perspective view showing the outer wind diverters of the wind turbine;

FIG. 11 is a side elevational view showing multiple modularized wind turbine units mounted to a water tower;

FIG. 12 is a front elevational view showing an electricity transmission system including the pole, the wind turbine and transformers;

FIG. 13 is a cross-sectional view, taken perpendicular to that of FIG. 6, showing a hubless and hollow generator, employed in the wind turbine;

FIG. 14 is a diagrammatic top view showing another embodiment of the wind turbine;

FIG. 15 is a partially fragmentary, perspective view showing another embodiment of the wind turbine; and

FIG. 16 is an enlarged and fragmentary cross-sectional view showing the wind turbine embodiment, taken along line 16-16 of FIG. 15.

### DETAILED DESCRIPTION

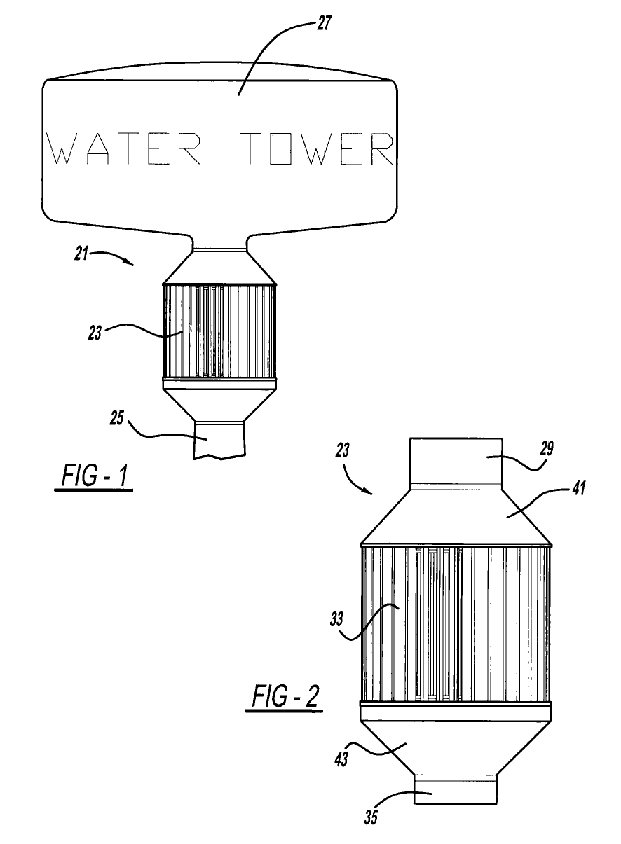

One embodiment of a wind turbine system 21 is shown in FIG. 1. Wind turbine system 21 includes a wind turbine 23 mounted to a generally middle section of a vertically elongated structure 25 such that the wind turbine is entirely elevated off of the ground by at least ten feet and with this configuration by at least 40 feet. Structure 25 is multi-functional by also serving to support a public utility device such as a water tower reservoir 27 above the wind turbine. Accordingly, water pipes are internally carried within structure 25 and therefore also through the hollow center of wind turbine 23.

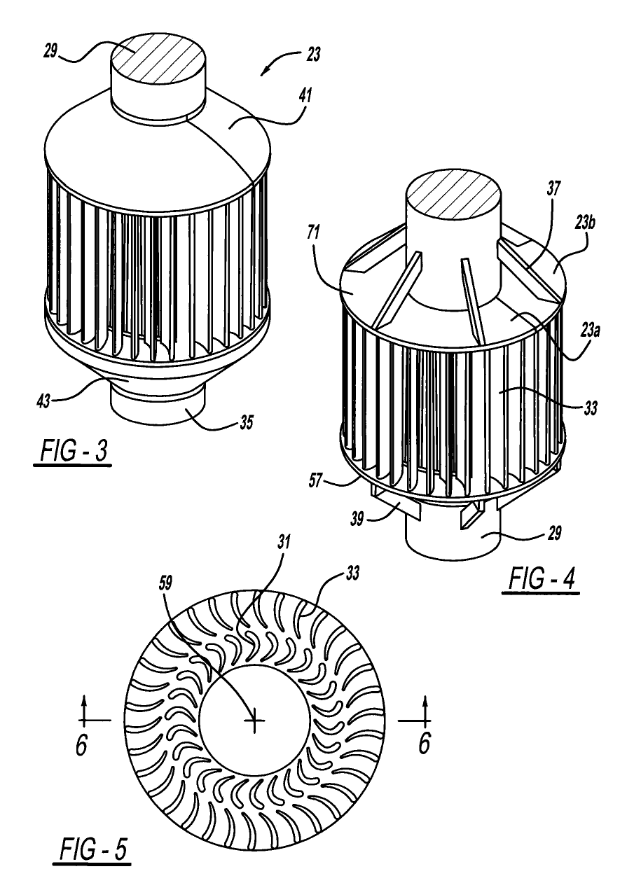

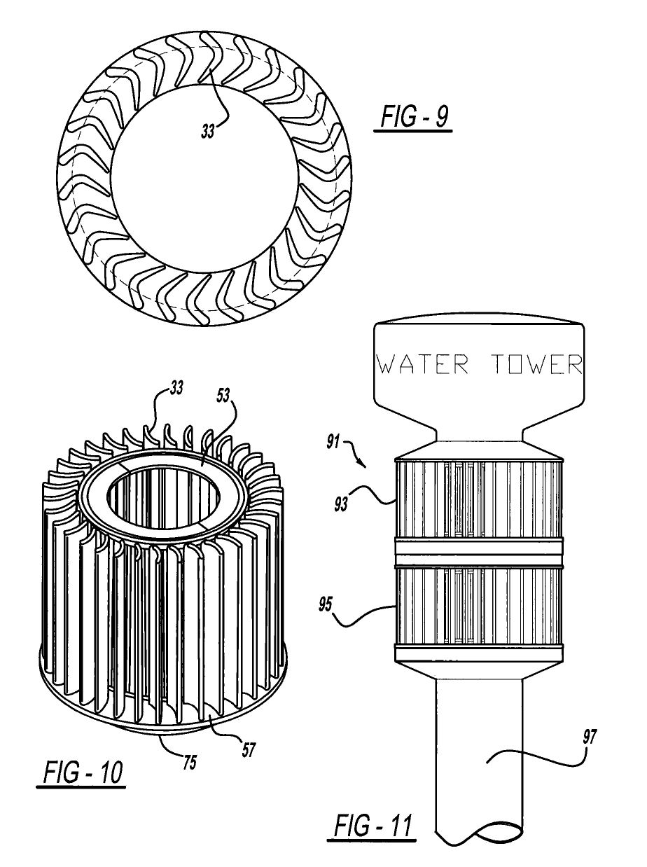

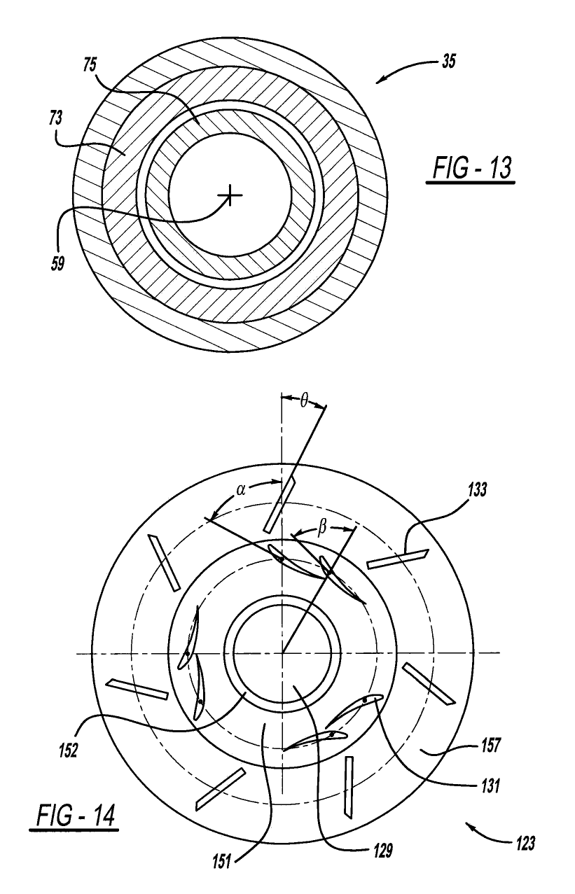

Referring now to FIGS. 2-10 and 13, wind turbine 23 is shown mounted onto another embodiment of a vertically elongated structure 29, in this situation a solid telephone or video communications pole, electrical pole or other similar type of structure. Wind turbine 23 includes a set of inner wind-driven blades or airfoils 31, a set of outer blades or wind diverters 33, a generator 35, upper mounting brackets 37, lower mounting brackets 39, and upper and lower covers 41 and 43, respectively. At least ten, and with this configuration at least thirty-four, inner blades 31 are fixed to an annular base 51 and an opposite annular ring 53. A circular ball bearing track, self-lubricating Rulon plane bearing (from TriStar Plastics Corp.), or opposed magnetic anti-frictional bearing track 55 is disposed between base 51 and an adjacent structural and stationary, annular platform 57 to allow the set of inner blades to freely rotate around a central vertical axis 59. Optionally, similar bearing tracks may be employed for rings 51 and 53.

Each inner blade 31 preferably has an airfoil or arcuate cross-sectional shape, such as disclosed in the Gual U.S. Pat. No. 6,309,172, however, other shapes can alternately be employed although performance may not be as desirable. It is envisioned that inner blades 31 are extruded from aluminum or made with an outer aluminum sheet adhered over a honeycomb-type of laminated core. Alternately, a fiber filled polymeric or carbon fabric composite can be used, or an injection molded polymer can be employed for small scale blades. Each inner blade 31 is elongated in a generally vertical direction substantially parallel to axis 59, however, it is envisioned that helically shaped, diagonally elongated or other such blade configurations can also be employed as long as they are somewhat elongated in the direction of axis 59.

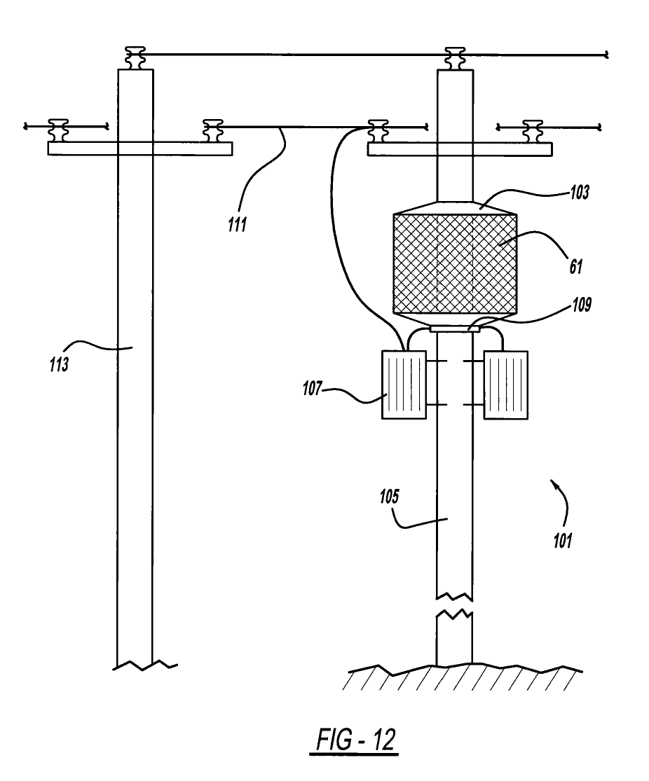

The set of outer diverter blades 33 remains generally stationary during normal use and concentrically surround inner blades 31. The inner and outer sets of blades are coaxially oriented to generally surround the adjacent portion of structure 29 and axis 59. It is alternately envisioned that outer blades 33 may be manually or automatically rotated or moved from a closed position to an open position, or between different wind directing positions, but are otherwise not intended to rotate around axis 59. At least ten, and more preferably at least thirty-four, outer blades are employed to hide the inner blades and adjacent portion of the structure. Furthermore, outer blades 33 act as wind diverters to direct the wind at desired angles into wind turbine 23 so as to most efficiently act upon and rotate inner blades 31 about central axis 59. Outer diverter blades 33 further reduce drag otherwise caused by the wind flowing to the opposite side of the internal blades 31. If the outer blades are spaced close enough, they may additionally reduce the risk of undesired bird or human limb entry into wind turbine. An outer or inner mesh grating, fence or air permeable fabric 61 (see FIG. 12) can optionally surround the set of outer blades to further camouflage the inner blade rotation and reduce undesired bird, insect, human limb and ice insertion. Alternately, the mesh may be located between the inner and outer sets of blades. Each outer blade 33 is elongated generally parallel to axis 59 but they may alternately have a helical, diagonal or other somewhat offset configuration. The outer blades are preferably manufactured out of the same materials as with the inner blades. Alternately, an elongated protective structure like hollow capillary tubes or a honeycomb structure is used to guide the wind straight at the inner blades.

Outer blades 33 are secured between platform 57 and an opposite platform 71. Steel or aluminum, or alternately composite or polymeric, diagonal or angle iron brackets 35 and 39 serve to stationarily secure platforms 71 and 57, respectively, to structure 29 by way of screws, rivets, welding or gluing. Aluminum, polymeric or composite covers 41 and 43 are removably fastened to the ends of the wind turbine unit, and each have a frusto-conical shape.

Generator or alternator 35 has an annular and hollow configuration, and includes an annular and hollow stator 73, and an annular and hollow armature 75 disposed concentrically therein. Armature 75 employs a magnet and is frameless, hubless and brushless. One or more upstanding brackets extending from rotatable armature 75 are directly coupled to rotatable base 51 which holds wind-driven inner blades 31; this provides a direct drive and solid coupling therebetween such that the rotating section of the generator is essentially integrated into the inner blade and base assembly of the wind turbine to move together as a single unit. Armature 75 is directly fastened to base 51 via tapped holes in the top of the armature and bottom of the base, clear of the central and hollow throughbores. Armature 75 has a rotational axis aligned with inner blade rotational axis 59 and armature 75 rotates around the outside of structure 29 during operation. This provides a well balanced rotational unit in combination with the set of inner blades thereby reducing undesirable binding, cocking and off-axis moment arms otherwise found with some conventional devices. The stator consists of an external housing made of an aluminum alloy bearing magnetic laminations, electrical windings, power cabling and thermal sensor cabling. The winding heads are encapsulated in a resin for protection and to decrease thermal resistance. The armature or rotor consists of a structure used as a magnetic yoke on which multiple magnets are fixed. The magnets are originally phosphatized and additionally coated with an anti-corrosion varnish, and thereafter protected from corrosion by grease. An acceptable generator can be obtained from Alxion of Colombes, France, as Model 300 STK, however, its central rotoric flange and hub must be removed to provide a hubless and hollow center, and its inside diameter will likely need to be increased. Generator stator 73 is stationarily coupled to an underside of platform 57. It is alternately envisioned that the stator and armature positions can be reversed so the armature moves about the outside and the stator is inside.

Referring to FIG. 14, a different blade configuration is shown for another embodiment of a hollow wind turbine 123. Seven generally straight guide vanes or blades 133 are located on a stator section 157, with each guide vane 133 having a tapered leading edge. Each guide vane 133 has a radially offset angle θ equal to or between 25°-60°, and optimally approximately 45° relative to a radial line through the vertical rotational axis.

Six inner wind-driven blades 131 are mounted to a rotor section 151 for rotation about a hollow central tube 152 disposed circumferentially around a vertical utility or water carrying pole or structure 129. Each inner blade 131 has an airfoil cross-sectional shape with a thicker leading end being slightly outboard more than the thinner trailing end, but the thickness difference being less than half the cross-section length of an inner blade. The inner blades are arranged in ganged pairs with a greater circumferential spacing between pairs than between the inner blades of each pair. The angle a of the leading inner blade of each pair relative to a radial line is equal to or between 40°-60° and optimally approximately 50°, and the angle β of the trailing inner blade of each pair relative to a radial line is equal to or between 40°-60° and optimally approximately 60°.

Furthermore, central pole 129 advantageously enhances the self-start up rotational performance of wind turbine 123 by creating a downstream wake to disrupt static equilibrium air flow forces otherwise created inside the turbine. Thus, a utility pole having a diameter of at least 8 cm (such that the outside diameter of pole 129 is at least 25% of the outside diameter of the set of inner blades 131), and more desireably greater than 20 cm, is expected to improve air flow characteristics and rotational efficiencies. The use of a tube 152 mounted to a stationary base of the wind turbine should provide similar self-start up advantages but with a more consistent and smoother (or patterned) surface than a pole made of rough wood or the like. The tube also provides improved modularized pre-assembly of the wind turbine for later final assembly onto an existing pole.

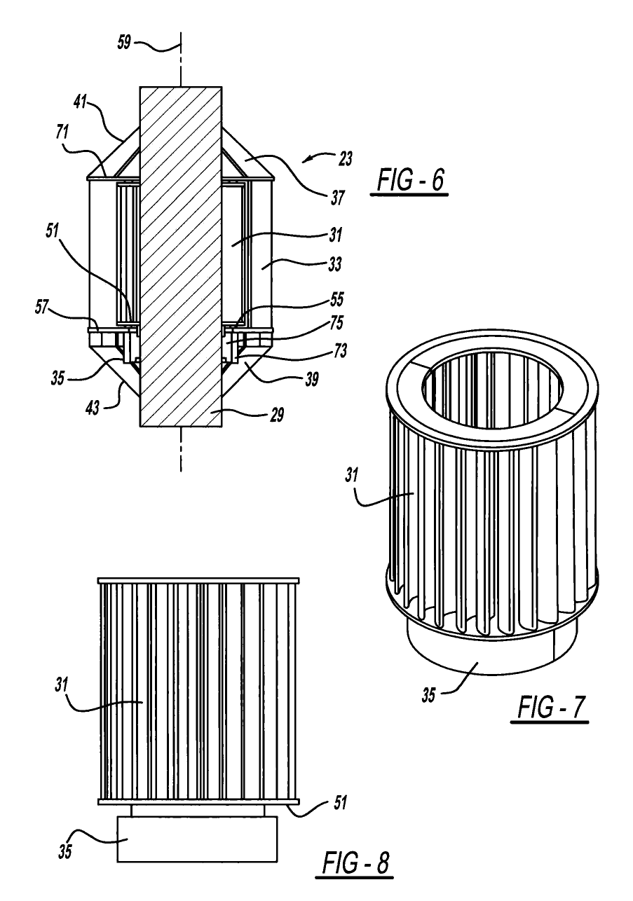

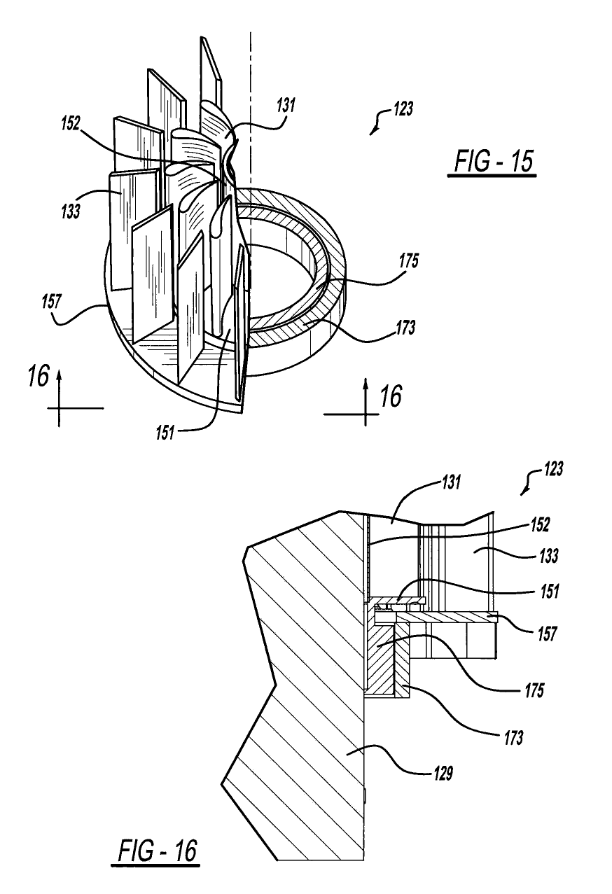

FIGS. 15 and 16 illustrate the directly driven and integrated construction of the generator with wind turbine 123. As with the embodiment of FIGS. 6-8, the present embodiment has a concentrically annular, hollow and hubless stator 173 and armature 175. Stator 173 is mounted to stationary platform 157 holding vanes 133. Armature 175 rotates with base 151 as a single piece or directly coupled subassembly, and base 151 holds and rotates with inner blades 131 about tube 152 and central post 129. Stator 173 and the magnetic segment of armature 175 have approximately the same vertical dimension and they have a vertical electromagnetic and mechanical interface throughout their facing circumferences as viewed in cross-section.

FIG. 15 further shows another configuration of inner blades 131 and outer diverter blades or vanes 133. In this embodiment there are twelve inner blades and fourteen diverter vanes 133, each being oriented in a direction closer to a radial line through the central axis than to circular lines intersecting all of the inner or outer blades. Each of blades 131 and 133 may optionally be manually, mechanically or electromagnetically rotated about its own axis to take advantage of different angular air flow characteristics, such as between initial startup and high speed operation.

It is alternately envisioned that generator 35 (see FIGS. 2 and 6) can be below, above, or duplicated above and below, the rotating inner blades. Furthermore, an alternate variation advantageously uses the permanent magnets of the rotor in combination with a magnetic bearing; thus, the magnet of the generator serves multiple purposes to reduce weight, and to minimize the mechanical friction and durability concerns of traditional bearings.

In one construction, wind turbine 23 is preassembled as two or more sub-assemblies or sub-units 23a and 23b (see FIG. 4). The major subassembly components are likewise subdivided. Thereafter, each sub-unit is located against a corresponding side of a pre-existing structure and then the sub-units can be fastened together through bolts, rivets, welding or the like. The entire wind turbine unit is also affixed to the structure before, after or during assembly of the two or more sub-units together. This allows for the present wind turbine to be attached to existing water towers, poles and other structures preattached to the ground, a building or the like. It is further envisioned that the unit can be subdivided into halves, thirds or other subsections for assembly onto a pole or tower. In another construction, the entire wind turbine unit is preassembled as a single unit with a hollow and hubless center. It is thereafter slid onto a new, elongated structure or one with an open end, until the mounting brackets reach their desired locations and are securely fastened thereto.

A modularized configuration of a wind turbine system 91 is shown in FIG. 11. In this embodiment, two or more modularized, wind turbine units 93 and 95 are stationarily attached to an elongated structure 97 such as a water tower, pole or the like. This allows for the inner blades to be rotated at independent and different speeds depending on the wind speed characteristics at different elevations off of the ground. Alternately, the different units can be counter-rotated opposite each other to balance rotational movement by cancelling inner blade torque on the assembly. Each wind turbine unit has its own associated hubless and hollow generator. The structure mounting bracketry and covers can be integrated, combined or unnecessary at adjacent interfaces but each wind turbine unit is otherwise the same as previously described hereinabove.

FIG. 12 shows an alternate embodiment wind turbine system 101. In this construction, a wind turbine 103, like that described with regard to FIG. 6, is mounted to a pole structure 105 carrying overhead electricity or communications wires. One or more electrical power transformers 107 are also affixed to structure 105 and are electrically connected to a hollow and hubless generator 109 of the type previously described hereinabove. Generator 109 and/or transformers 107 are electrically connected to the overhead electricity carrying wires 111. It is also noteworthy that structure 105 is carrying electrical wires between multiple other structures 113 or buildings. Thus, structure 105 is serving a multi-functional purpose rather than requiring a dedicated and unique wind turbine mast as with conventional devices.

While various embodiments have been described herein, it should be appreciated that variations may be made without departing from the present invention. For example, vertically elongated structures have been shown, however, diagonally or horizontally elongated structures may be employed with the present hubless and hollow wind turbine assemblies although all of the disclosed advantages may not be fully realized. Furthermore, additional wind diverters, external and/or internal to the inner rotating blades, may be employed to provide desired air flow characteristics depending upon the specific end use application, environmental conditions and generator cooling requirements. Moreover, a dedicated structural pole or tower can be employed to extend through an otherwise hollow wind turbine, however, the multifunctional cost and aesthetic benefits may not be achieved. It should also be appreciated that certain aspects of the present wind turbine may be used without the preferred generator, although various advantages may be lost. As another alternate embodiment, a small sized wind turbine can be mounted on a portable pole which can be temporarily hand carried and stuck in the ground for powering a motor home or the like; such a configuration has a reduced quantity of inner and outer blades but optimally at least six of each. While various materials have been disclosed, other materials may alternately be employed as long as the disclosed function is achieved. It is intended by the following claims to cover these and any other departures from the disclosed embodiments which fall within the true spirit of this invention.

The invention claimed is:

1. A wind turbine system comprising:
a hubless and hollow wind turbine including a set of wind-driven blades rotatable about a central axis; and
an electric generator including a member rotatable about the central axis in response to movement of the blades, the member having a hubless and hollow center substantially aligned with the central axis of the wind turbine.

2. The wind turbine system of claim 1, further comprising a utility pole, the wind turbine being mounted to the utility pole.

3. The wind turbine system of claim 2, further comprising a transformer mounted to the utility pole and the generator being electrically connected to the transformer.

4. The wind turbine system of claim 1, further comprising a water tower structure, the wind turbine being mounted to a substantially middle section of the structure, and a water carrying pipe extending through a hollow center of the wind turbine.

5. The wind turbine system of claim 1, wherein the wind turbine includes coaxial and central upper and lower openings, further comprising a vertically elongated pole extending through the openings, and the wind-driven blades rotating about the pole.

6. The wind turbine system of claim 1, further comprising a set of wind diverters arranged in a substantially concentric manner surrounding the set of wind-driven blades, wherein there are at least as many wind diverters as wind-driven blades.

7. The wind turbine system of claim 1, further comprising diagonally oriented mounting brackets coupling upper and lower portions of the wind turbine to a stationary vertical structure extending through the upper and lower portions.

8. The wind turbine system of claim 1, wherein each of the wind-driven blades is vertically elongated, substantially parallel to the central axis, and has a substantially uniform airfoil cross-sectional shape.

9. A wind turbine system comprising:
a hubless wind turbine including a set of wind-driven blades rotatable about a central axis; and
a generator including an annular magnetic armature and an annular stator;
the armature being directly driven and operably rotated by the wind turbine through at least one solid coupling;
the armature and stator being concentrically located relative to each other and having a hubless through bore;
the armature and stator having an electromagnetic interface substantially parallel to the central axis when viewed in cross-section; and
the armature operably rotating about the central axis at essentially the same speed as the wind-driven blades.

10. The wind turbine system of claim 9, further comprising a utility pole, the wind turbine being mounted to the utility pole.

11. The wind turbine system of claim 9, further comprising a water tower structure, the wind turbine being mounted to a substantially middle section of the structure.

12. The wind turbine system of claim 9, further comprising a set of wind diverters arranged in a substantially concentric manner surrounding the set of wind-driven blades, wherein there are at least as many wind diverters as wind-driven blades and the wind diverters are prevented from rotating around the central axis.

13. The wind turbine system of claim 9, wherein each of the wind-driven blades is vertically elongated, substantially parallel to the central axis, and has a substantially uniform airfoil cross-sectional shape.

14. The wind turbine system of claim 9, wherein the stator includes resin encapsulated electrical windings and the armature includes at least one permanent magnet coated with an anti-corrosion material, and the armature is directly connected to an annular base as a single assembly or piece, and the base supports the wind-driven blades.

15. The wind turbine system of claim 9, wherein the central axis is substantially vertical.

16. The wind turbine system of claim 9, wherein the central axis is substantially horizontal.

17. A wind turbine system comprising:
an elongated and multi-functional structure;
a wind turbine mounted to and substantially surrounding a portion of the structure, the wind turbine including a set of wind-driven blades operably rotating around the portion of the structure; and
a utility member mounted to the structure, the utility member including at least one of: (a) a water tower reservoir; (b) a power transformer; and (c) an overhead electricity or communications transmitting wire between other structures.

18. The wind turbine system of claim 17, wherein the structure is a utility pole, and further comprising a generator coupled to the wind turbine, the generator being connected to the transformer mounted to the utility pole, and the wind-driven blades and generator rotate around the utility pole.

19. The wind turbine system of claim 17, wherein the portion is a substantially middle portion of the structure and the wind turbine is mounted to the substantially middle portion so that the structure vertically extends completely through the wind turbine, further comprising brackets mounting upper and lower portions of the wind turbine to the structure.

20. The wind turbine system of claim 17, further comprising a set of wind diverters arranged in a substantially concentric manner surrounding the set of wind-driven blades, wherein there are at least as many wind diverters as wind-driven blades.

21. The wind turbine system of claim 17, wherein each of the wind-driven blades is vertically elongated, substantially parallel to a central axis of the structure, and has a substantially uniform airfoil cross-sectional shape.

22. A wind turbine system comprising:
a substantially vertically elongated structure;
a first hollow wind turbine unit mounted to and substantially surrounding a first portion of the structure, the first wind turbine unit including rotatable blades each having a substantially vertical elongation direction; and
at least a second wind turbine unit mounted to and substantially surrounding a second and different portion of the structure, the second wind turbine unit including rotatable blades each having a substantially vertical elongation direction;
the blades of the first and second wind turbine units being rotatable at different speeds around the structure if different wind conditions act upon the respective wind turbine units.

23. The wind turbine system of claim 22, wherein the first wind turbine unit includes coaxial and central upper and lower openings through which the structure extends, brackets securing top and bottom portions of the first wind turbine unit to the structure.

24. The wind turbine system of claim 22, wherein the structure is a utility pole which assists with air flow characteristics within the first wind turbine unit in at least one operating condition.

25. The wind turbine system of claim 22, wherein the structure is a water tower member with a water pipe extending through both of the wind turbine units.

26. The wind turbine system of claim 22, further comprising for each of the wind turbine units, a set of wind diverters being arranged in a substantially concentric manner surrounding the set of rotatable blades, wherein there are at least as many wind diverters as rotatable blades.

27. The wind turbine system of claim 22, wherein each of the wind turbine units includes a hollow, hubless and annular generator attached thereto surrounding the structure.

28. A wind turbine system comprising:
an elongated structure;
a set of inner wind-driven airfoils operably rotatable about the structure;
a set of outer wind diverters being externally arranged relative to the set of inner airfoils;
a base coupled to the inner airfoils for rotation therewith, the base having a central throughbore through which the structure extends; and
a stationary platform supporting the wind diverters;
the set of airfoils, set of diverters, base and platform being divided into at least two subassemblies for attachment together to surround a substantially middle section of the structure;
a set of mounting brackets being arranged with a hollow center substantially coaxially aligned with the rotational axis of the inner airfoils, the brackets coupling the platform to the structure.

29. The wind turbine system of claim 28, wherein the structure is a substantially vertical utility pole.

30. The wind turbine system of claim 28, wherein the structure is a water tower member.

31. The wind turbine system of claim 28, wherein each of the airfoils and wind diverters are elongated in a substantially vertical direction substantially parallel to the structure, and the base, platform, airfoils, diverters and brackets are preassembled and thereafter mounted to the structure which is pre-existing.

32. A method of operating a wind turbine comprising:
(a) rotating a set of wind-driven members around a substantially middle section of a vertical structure;
(b) rotating a hollow part of a generator around the structure in response to step (a); and
(c) generating electricity in response to step (b); and
(d) operating a utility device mounted adjacent a top of the structure extending above the wind-driven members.

33. The method of claim 32, further comprising directly driving a generator by rotation of the members at the same speed as rotation of the part which is an armature of the generator around the structure, and using a substantially vertical and concentric interface between a stator and the armature which are both annular to cause electromagnetism therebetween in the generator.

34. The method of claim 32, further comprising attaching the wind turbine around the structure which is pre-existing and also using the utility device to support power transmission lines between adjacent utility poles.

35. The method of claim 32, wherein the structure is a utility pole and using the utility pole to assist with air flow characteristics within the wind turbine in at least one operating condition.
